(19) United States
(12) Patent Application Publication
(10) Pub. No.: US 2025/0166927 A1
(43) Pub. Date: May 22, 2025

(54) CAPACITOR ELEMENT

(71) Applicant: Murata Manufacturing Co., Ltd., Nagaokakyo-shi (JP)

(72) Inventors: Masanori YOSHIKAWA, Nagaokakyo-shi (JP); Akitomo TAKAHASHI, Nagaokakyo-shi (JP)

(21) Appl. No.: 19/007,874

(22) Filed: Jan. 2, 2025

Related U.S. Application Data
(63) Continuation of application No. PCT/JP2024/017754, filed on May 14, 2024.

(30) Foreign Application Priority Data
Jun. 16, 2023 (JP) 2023-099240

(51) Int. Cl. H01G 9/012; H01G 9/048; H01G 9/15

(52) U.S. Cl. CPC H01G 9/012; H01G 9/048; H01G 9/15

(57) ABSTRACT

A capacitor element that includes: a capacitor portion including an anode plate including a core portion and a porous portion on the core portion, a dielectric layer on the porous portion, and a cathode layer on the dielectric layer 13; a seal layer covering the capacitor portion; a first through-hole conductor extending through the capacitor portion and the seal layer and electrically directly connected to the anode plate 11; a second through-hole conductor extending through the capacitor portion and the seal layer and electrically directly connected to the cathode layer; a first outer electrode layer on a surface of the seal layer and electrically connected to the first through-hole conductor, wherein at least a part of the first outer electrode layer overlaps the cathode layer in the thickness direction; and a second outer electrode layer on a surface of the seal layer and electrically connected to the second through-hole conductor.

### CROSS REFERENCE TO RELATED APPLICATIONS

The present application is a continuation of International application No. PCT/JP2024/017754, filed May 14, 2024, which claims priority to Japanese Patent Application No. 2023-099240, filed Jun. 16, 2023, the entire contents of each of which are incorporated herein by reference.

### TECHNICAL FIELD

The present disclosure relates to a capacitor element.

### BACKGROUND ART

Patent Document 1 describes a solid electrolytic capacitor. The solid electrolytic capacitor includes a foil-shaped anode including a porous portion at at least one surface and having a through-hole at a predetermined position, a dielectric film disposed at the porous portion of the anode, an insulating layer having a hole and formed at the dielectric film, a solid electrolyte layer disposed at the dielectric film in the hole of the insulating layer, a cathode disposed at at least a part of the solid electrolyte layer and arranged substantially in parallel to the anode, an electrode disposed at the insulating layer, and through-hole electrodes extending through the insulating layer and the anode and electrically connecting the electrode and the anode to each other and/or extending through the insulating layer and the cathode and electrically connecting the electrode and the cathode to each other, wherein at least one of the through-hole electrodes has a long hole shape.
Patent Document 1: Japanese Unexamined Patent Application Publication No. 2007-281111

### SUMMARY OF THE DISCLOSURE

With size reduction and an increased output of an electronic device in recent years, high-density packaging of components is desired. To this end, embedding of a capacitor element in a substrate immediately below a power source, for example, in a graphical processing unit (GPU) substrate has been examined. For this purpose of use, a large current flows through an electronic device. However, the structure of an existing capacitor element has insufficient heat dissipation properties, and thus the internal resistance of the capacitor element may generate heat. Such heat generation from the components may adversely affect, for example, safety, reliability, performance, or lifetime of the electronic device.

The solid electrolytic capacitor described in Patent Document 1 also has room for improvement in terms of heat dissipation properties.

The present disclosure has been made to solve the above issue, and aims to provide a capacitor element that has improved heat dissipation properties.

The present disclosure provides a capacitor element that includes: a capacitor portion including: an anode plate including a core portion and a porous portion at at least one main surface of the core portion, a dielectric layer at a surface of the porous portion, and a cathode layer at a surface of the dielectric layer; a seal layer covering the capacitor portion; a first through-hole conductor extending through the capacitor portion and the seal layer in a thickness direction and electrically directly connected to the anode plate, and having two end portions drawn out to a surface of the seal layer; a second through-hole conductor extending through the capacitor portion and the seal layer in the thickness direction and electrically directly connected to the cathode layer, and having two end portions drawn out to the surface of the seal layer; a first outer electrode layer at the surface of the seal layer and electrically connected to the first through-hole conductor, wherein at least a part of the first outer electrode layer overlaps the cathode layer in the thickness direction; and a second outer electrode layer at a surface of the seal layer and electrically connected to the second through-hole conductor.

The present disclosure can provide a capacitor element that has improved heat dissipation properties.

### BRIEF DESCRIPTION OF DRAWINGS

FIG. 1 is a schematic cross-sectional view of an example of a capacitor element according to a first embodiment of the present disclosure.

FIG. 2 is a plan view of the capacitor element illustrated in FIG. 1, taken along line A-A.

FIG. 3 is a plan view of the capacitor element illustrated in FIG. 1, taken along line B-B.

FIG. 4 is a plan view of the capacitor element illustrated in FIG. 1, taken along line C-C.

FIG. 5 is a schematic cross-sectional view of another example of the capacitor element according to the first embodiment of the present disclosure.

FIG. 6-1 is a cross-sectional schematic view of an example of a method for manufacturing the capacitor element illustrated in FIG. 1, illustrating a process of preparing an anode plate.

FIG. 6-2 is a cross-sectional schematic view of an example of a method for manufacturing the capacitor element illustrated in FIG. 1, illustrating a process of forming dielectric layers.

FIG. 6-3 is a cross-sectional schematic view of an example of a method for manufacturing the capacitor element illustrated in FIG. 1, illustrating a process of forming insulating mask layers.

FIG. 6-4 is a cross-sectional schematic view of an example of a method for manufacturing the capacitor element illustrated in FIG. 1, illustrating a process of forming solid electrolyte layers.

FIG. 6-5 is a cross-sectional schematic view of an example of a method for manufacturing the capacitor element illustrated in FIG. 1, illustrating a process of forming first conductor layers.

FIG. 6-6 is a cross-sectional schematic view of an example of a method for manufacturing the capacitor element illustrated in FIG. 1, illustrating a process of forming a through-hole.

FIG. 6-7 is a cross-sectional schematic view of an example of a method for manufacturing the capacitor element illustrated in FIG. 1, illustrating a process of forming an insulating member.

FIG. 6-8 is a cross-sectional schematic view of an example of a method for manufacturing the capacitor element illustrated in FIG. 1, illustrating a process of grinding the insulating member.

FIG. 6-9 is a cross-sectional schematic view of an example of a method for manufacturing the capacitor element illustrated in FIG. 1, illustrating a process of forming second conductor layers.

FIG. 6-10 is a cross-sectional schematic view of an example of a method for manufacturing the capacitor element illustrated in FIG. 1, illustrating a process of forming seal layers.

FIG. 6-11 is a cross-sectional schematic view of an example of a method for manufacturing the capacitor element illustrated in FIG. 1, illustrating a process of forming a first through-hole and a second through-hole.

FIG. 6-12 is a cross-sectional schematic view of an example of a method for manufacturing the capacitor element illustrated in FIG. 1, illustrating a process of forming through-hole conductors and outer electrode layers.

FIG. 7-1 is a cross-sectional schematic view of another example of a method for manufacturing the capacitor element illustrated in FIG. 1, illustrating a state after a through-hole is formed.

FIG. 7-2 is a cross-sectional schematic view of another example of a method for manufacturing the capacitor element illustrated in FIG. 1, illustrating a process of forming an insulating member.

FIG. 7-3 is a cross-sectional schematic view of another example of a method for manufacturing the capacitor element illustrated in FIG. 1, illustrating a process of forming second conductor layers.

FIG. 7-4 is a cross-sectional schematic view of another example of a method for manufacturing the capacitor element illustrated in FIG. 1, illustrating a process of forming seal layers.

FIG. 7-5 is a cross-sectional schematic view of another example of a method for manufacturing the capacitor element illustrated in FIG. 1, illustrating a process of forming a first through-hole and a second through-hole.

FIG. 7-6 is a cross-sectional schematic view of another example of a method for manufacturing the capacitor element illustrated in FIG. 1, illustrating a process of forming through-hole conductors and outer electrode layers.

FIG. 8 is a schematic plan view of an example of a capacitor element according to a second embodiment of the present disclosure.

FIG. 9-1 is a cross-sectional schematic view of an example of a method for manufacturing the capacitor element illustrated in FIG. 8, illustrating a process of preparing an anode plate.

FIG. 9-2 is a cross-sectional schematic view of an example of a method for manufacturing the capacitor element illustrated in FIG. 8, illustrating a process of forming a dielectric layer.

FIG. 9-3 is a cross-sectional schematic view of an example of a method for manufacturing the capacitor element illustrated in FIG. 8, illustrating a process of forming an insulating mask layer.

FIG. 9-4 is a cross-sectional schematic view of an example of a method for manufacturing the capacitor element illustrated in FIG. 8, illustrating a process of forming a solid electrolyte layer.

FIG. 9-5 is a cross-sectional schematic view of an example of a method for manufacturing the capacitor element illustrated in FIG. 8, illustrating a process of forming a first conductor layer.

FIG. 9-6 is a cross-sectional schematic view of an example of a method for manufacturing the capacitor element illustrated in FIG. 8, illustrating a process of forming a through-hole.

FIG. 9-7 is a cross-sectional schematic view of an example of a method for manufacturing the capacitor element illustrated in FIG. 8, illustrating a process of forming an insulating member.

FIG. 9-8 is a cross-sectional schematic view of an example of a method for manufacturing the capacitor element illustrated in FIG. 8, illustrating a process of grinding the insulating member.

FIG. 9-9 is a cross-sectional schematic view of an example of a method for manufacturing the capacitor element illustrated in FIG. 8, illustrating a process of forming a second conductor layer.

FIG. 9-10 is a cross-sectional schematic view of an example of a method for manufacturing the capacitor element illustrated in FIG. 8, illustrating a process of forming a seal layer.

FIG. 9-11 is a cross-sectional schematic view of an example of a method for manufacturing the capacitor element illustrated in FIG. 8, illustrating a process of forming a first through-hole and a second through-hole.

FIG. 9-12 is a cross-sectional schematic view of an example of a method for manufacturing the capacitor element illustrated in FIG. 8, illustrating a process of forming through-hole conductors and an outer electrode layer.

### DESCRIPTION OF THE PREFERRED EMBODIMENTS

A capacitor element according to the present disclosure is described below. The present disclosure is not limited to the structure described below, but may be changed as appropriate within a range not departing from the gist of the present disclosure. In addition, a combination of multiple preferable components described below is also included in the present disclosure.

Each embodiment described below is a mere example, and components in different embodiments may be partially replaced with each other or combined with each other. In second and subsequent embodiments, the same points as those in the first embodiment are not described, and only different points are mainly described. Particularly, the same effects in the same structures are not described one by one for each embodiment.

In the description below, a capacitor element is simply referred to as “a capacitor element according to the present disclosure” when the embodiments are not particularly distinguished from one another.

Herein, the terms indicating the relationship between components (for example, “vertical”, “parallel”, or “orthogonal”) and the terms indicating the shape of components do not indicate only the precise meanings, but also include a substantially equivalent range, for example, a difference within about several percent.

The drawings described below are schematic diagrams, and may differ from the actual products in terms of, for example, the dimensions or the aspect ratios.

### First Embodiment

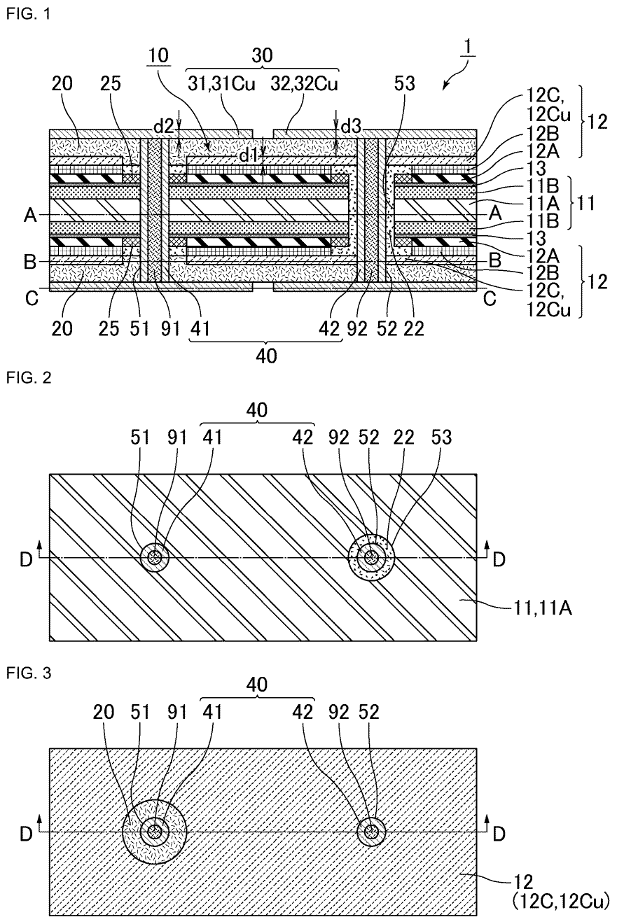

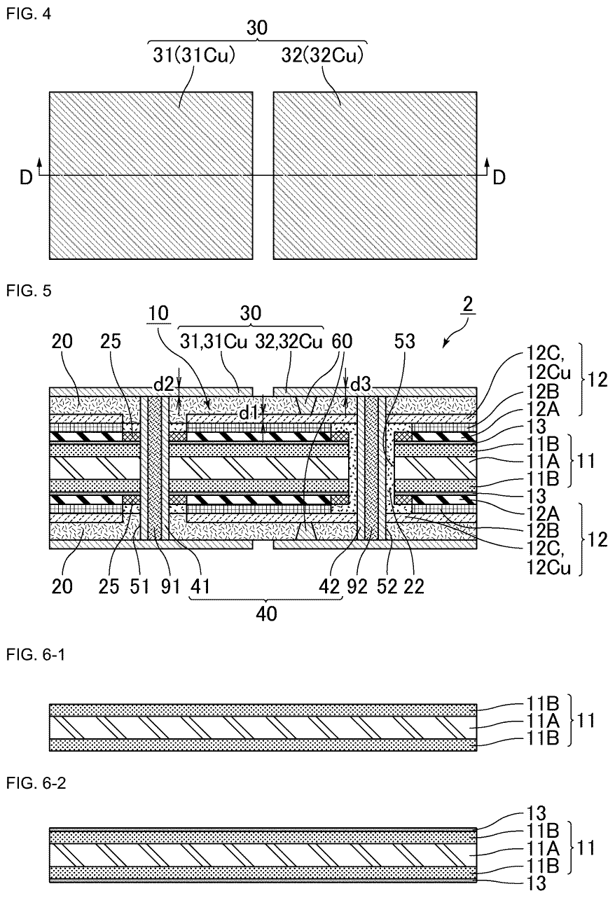

FIG. 1 is a schematic cross-sectional view of an example of a capacitor element according to a first embodiment of the present disclosure. FIG. 2 is a plan view of the capacitor element illustrated in FIG. 1, taken along line A-A. FIG. 3 is a plan view of the capacitor element illustrated in FIG. 1, taken along line B-B. FIG. 4 is a plan view of the capacitor element illustrated in FIG. 1, taken along line C-C. FIG. 1 is a cross-sectional view of the capacitor element taken along line D-D illustrated in FIG. 2 to FIG. 4.

A capacitor element 1 illustrated in FIG. 1 to FIG. 4 includes a capacitor portion 10, a seal layer 20 disposed to cover the capacitor portion 10, through-hole conductors 40 disposed to extend through the capacitor portion 10 and the seal layers 20 in a thickness direction and having both end portions drawn out to surfaces of the seal layer 20, and outer electrode layers 30 disposed at surfaces of the seal layer 20 to be electrically connected to the through-hole conductors 40.

In the example illustrated in FIG. 1 to FIG. 4, one capacitor portion 10 is disposed inside the seal layer 20. However, the number of the capacitor portion 10 disposed inside the seal layer 20 is not limited to a particular one, and one or more capacitor portions 10 may be disposed.

The capacitor portion 10 includes an anode plate 11 including a core portion 11A and a porous portion 11B at at least one main surface of the core portion 11A, a dielectric layer 13 disposed at the surface of the porous portion 11B, and a cathode layer 12 disposed at the surface of the dielectric layer 13. Thus, the capacitor portion 10 constitutes an electrolytic capacitor. In the example illustrated in FIG. 1, the anode plate 11 includes the core portion 11A and the porous portion 11B on each of both main surfaces of the core portion 11A, but may include the porous portion 11B simply on one main surface of the core portion 11A.

The cathode layer 12 includes, for example, a solid electrolyte layer 12A disposed at the surface of the dielectric layer 13. When the cathode layer 12 includes the solid electrolyte layer 12A, the capacitor portion 10 constitutes a solid electrolytic capacitor.

As illustrated in FIG. 1, the seal layer 20 is preferably disposed at each of both main surfaces of the capacitor portion 10 opposite to each other in the thickness direction. The seal layer 20 protects the capacitor portion 10.

The seal layer 20 may include one layer or two or more layers. When the seal layer 20 includes two or more layers, the layers may be formed from the same material or different materials.

The seal layer 20 is formed by a method such as thermocompression bonding an insulating resin sheet, or a applying insulating resin paste and then thermosetting the insulating resin paste, to seal the capacitor portion 10.

In the example illustrated in FIG. 1, the through-hole conductors 40 include a first through-hole conductor 41 electrically connected to the anode plate 11, and a second through-hole conductor 42 electrically connected to the cathode layer 12.

The first through-hole conductor 41 may be disposed at at least an inner wall surface of a first through-hole 51 extending through the capacitor portion 10 and the seal layer 20 in the thickness direction. The first through-hole conductor 41 may be disposed simply on the inner wall surface of the first through-hole 51, or may be disposed throughout the inside of the first through-hole 51.

As illustrated in FIG. 3, when viewed in plan in the thickness direction, one first through-hole conductor 41 or two or more first through-hole conductors 41 may be disposed inside the cathode layer 12.

The second through-hole conductor 42 may be disposed at at least the inner wall surface of a second through-hole 52 extending through the capacitor portion 10 and the seal layer 20 in the thickness direction. The second through-hole conductor 42 may be simply disposed at the inner wall surface of the second through-hole 52, or may be disposed throughout the inside of the second through-hole 52.

As illustrated in FIG. 1, preferably, a space between the second through-hole conductor 42 and the capacitor portion 10 (particularly, the anode plate 11) is filled with an insulating member 22.

As illustrated in FIG. 3, when viewed in plan in the thickness direction, one second through-hole conductor 42 or two or more second through-hole conductors 42 may be disposed inside the cathode layer 12.

Although not illustrated in FIG. 1 to FIG. 4, the through-hole conductors 40 may include a third through-hole conductor not electrically connected to the anode plate 11 and the cathode layer 12.

The outer electrode layers 30 include a first outer electrode layer 31 electrically connected to the first through-hole conductor 41 and the anode plate 11, and a second outer electrode layer 32 electrically connected to the second through-hole conductor 42 and the cathode layer 12.

One first outer electrode layer 31 or multiple first outer electrode layers 31 may be disposed at each capacitor portion 10. Similarly, one second outer electrode layer 32 or multiple second outer electrode layers 32 may be disposed at each capacitor portion 10. For each capacitor portion 10, the number of the first outer electrode layers 31 may be the same as or different from the number of the second outer electrode layers 32.

The flat plate shape of the outer electrode layer 30 when viewed in the thickness direction is not limited in particular, and may be, for example, a polygon such as a rectangle (a square or a rectangle), a quadrilateral excluding a rectangle, a triangle, a pentagon, or a hexagon, a circle, an ellipse, or a shape combining any two or more of these. The flat plate shape of the outer electrode layer 30 may be, for example, an L shape, a C shape (an angular C shape), or a staircase shape.

The flat plate shape of the first outer electrode layer 31 when viewed in the thickness direction may be the same as or different from the flat plate shape of the second outer electrode layer 32 when viewed in the thickness direction.

As in the case illustrated in FIG. 5 described below, the cathode layer 12 may be drawn out with an inner via conductor. However, in the example illustrated in FIG. 1, the second through-hole conductor 42 is electrically directly connected to the cathode layer 12, and the cathode layer 12 is drawn out with the second through-hole conductor 42. Compared with the case where the cathode layer 12 is drawn out with simply an inner via conductor, the second through-hole conductor 42 thus electrically directly connected to the cathode layer 12 can increase a heat dissipation path, that is, a heat dissipation area. In the example illustrated in FIG. 1, at least a part of the first outer electrode layer 31 overlaps the cathode layer 12 in the thickness direction, and thus, the heat dissipation area increases. Thus, the heat dissipation properties of the capacitor element 1 can be improved. Thus, a temperature rise caused by heat generation of the capacitor element 1 can be reduced.

When the second through-hole conductor 42 is electrically directly connected to the cathode layer 12, the second through-hole conductor 42 and the cathode layer 12 directly come into contact with each other without using a resin portion formed from a different material. Thus, the rigidity of the capacitor element 1 can be improved. Similarly, at least a part of the first outer electrode layer 31 overlaps the cathode layer 12 in the thickness direction. Thus, the area of the first outer electrode layer 31 can be increased, and the rigidity of the capacitor element 1 can be improved. As in the case of the example illustrated in FIG. 1, when the cathode layer 12 is drawn out without using an inner via conductor, the thickness of the capacitor element 1 can be reduced, but the capacitor element 1 may be warped. However, when the first outer electrode layer 31 overlaps the cathode layer 12, the rigidity of the capacitor element 1 is improved, and the occurrence of such warpage may be reduced.

In addition, when at least a part of the first outer electrode layer 31 overlaps the cathode layer 12 in the thickness direction, the area of the first outer electrode layer 31 can be increased, and intrusion of, for example, water or oxygen into the capacitor portion 10 from the outside can be reduced.

Herein, the expression that the through-hole conductor is electrically directly connected to a conductor layer such as a cathode layer or an anode plate indicates that a case of simply including a structure (a connection path) where the through-hole conductor is electrically connected to a conductor layer with a via conductor or an outer electrode layer is excluded. In this case, the through-hole conductor is electrically connected to a conductor layer at the inner wall surface of the through-hole, more specifically, a side wall portion of the through-hole conductor is electrically connected to a conductor layer. In the example illustrated in FIG. 1, the second through-hole conductor 42 is electrically connected to the cathode layer 12 at the inner wall surface of the second through-hole 52.

In the example illustrated in FIG. 1, the first through-hole conductor 41 is also electrically directly connected to the anode plate 11, and the first through-hole conductor 41 is electrically connected to the anode plate 11 at the inner wall surface of the first through-hole 51.

As illustrated in FIG. 1, only a part of the first outer electrode layer 31 may overlap the cathode layer 12 in the thickness direction. The ratio of an area of a portion of the first outer electrode layer 31 overlapping the cathode layer 12 in the thickness direction to the entire area of the first outer electrode layer 31 is not limited to a particular one, but is preferably greater than or equal to 50% and less than or equal to 90%, or more preferably, greater than or equal to 60% and less than or equal to 80%.

As illustrated in FIG. 1, the cathode layer 12 may include a copper layer 12Cu, the first outer electrode layer 31 may include a copper layer 31Cu, and the second outer electrode layer 32 may include a copper layer 32Cu. In this case, when the thickness of the copper layer 12Cu of the cathode layer 12 is d1, the thickness of the copper layer 31Cu of the first outer electrode layer 31 is d2, and the thickness of the copper layer 32Cu of the second outer electrode layer 32 is d3, preferably, d1≥d2 and d1≥d3 are satisfied. Thus, concentration of current on the cathode layer 12 can be reduced, and heat generation can be reduced. With an increase of the volume of the copper layer 12Cu of the cathode layer 12, thermal diffusion can be promoted, and damage on the capacitor portion 10 can be reduced.

The ratio of d1 to d2, that is, d1/d2 preferably satisfies 1<d1/d2<3, or more preferably satisfies 1.5<d1/d2<2.5. The ratio of d1 to d3, that is, d1/d3 preferably satisfies 1<d1/d3<3, or more preferably satisfies 1.5<d1/d3<2.5.

In the example illustrated in FIG. 1, the copper layer 12Cu is a second conductor layer 12C of the cathode layer 12 described later, the copper layer 31Cu is the first outer electrode layer 31, and the copper layer 32Cu is the second outer electrode layer 32.

When the cathode layer 12 includes multiple layers including the copper layer 12Cu, the copper layer 12Cu is preferably one or more of the layers included in the cathode layer 12, located closest to the first outer electrode layer 31 and the second outer electrode layer 32.

When the first outer electrode layer 31 includes multiple layers including the copper layer 31Cu, the copper layer 31Cu may be any one of the multiple layers included in the cathode layer 12. The same applies to the second outer electrode layer 32.

From the view point of heat dissipation properties, the volume of the anode and the volume of the cathode in the capacitor element 1 preferably match each other. Based on the comparison between the volume of the anode plate 11 and the volume of the cathode layer 12, a preferable area ratio between the first outer electrode layer 31 and the second outer electrode layer 32 is described.

The thickness of the core portion 11A of the anode plate 11 is, for example, greater than or equal to 40 μm and less than or equal to 60 μm, and, the area of the core portion 11A of the anode plate 11 is assumed as being substantially 100% in the plane in FIG. 2 taken along line A-A in FIG. 1. The thickness of the copper layer 12Cu of each cathode layer 12 is, for example, substantially 30 μm on each of both main surfaces of the anode plate 11, and the area of the copper layer 12Cu is assumed as being substantially 100% in the plane in FIG. 3 taken along line B-B in FIG. 1.

The thermal conductivity of copper is substantially 1.7 times the thermal conductivity of aluminum that is preferable as a material of the anode plate 11. As described above, the area of the core portion 11A of the anode plate 11 is substantially the same as the area of the copper layer 12Cu of the cathode layer 12 on each of both sides of the core portion 11A. When the total thickness of the copper layers 12Cu of the cathode layers 12 on both sides of the core portion 11A is 60 μm, the thickness that the core portion 11A of the anode plate 11 needs to have is 60×1.7=102 μm. Thus, the cathode is advantageous to the anode in terms of thermal conductivity (heat dissipation properties). As described in a second embodiment below, when an inner via conductor is connected to the cathode layer 12, the cathode is further advantageous in terms of thermal conductivity (heat dissipation properties).

From the view point of correcting the imbalance of the volumes between the anode and the cathode inside and further improving the heat dissipation properties, preferably, S1>S2 is to be satisfied where the area of the first outer electrode layer 31 electrically connected to the anode plate 11 is denoted with S1 and the area of the second outer electrode layer 32 electrically connected to the cathode layer 12 is denoted with S2. When S1>S2 is satisfied, undulation of the substrate on which the capacitor element 1 is mounted can be reduced.

Herein, a simple expression of “an area” refers to the area in a plan view in the thickness direction.

As illustrated in FIG. 1, when the first outer electrode layer 31 and the second outer electrode layer 32 are disposed on both main surfaces of the capacitor portion 10, preferably, S1>S2 is to be satisfied on both main surfaces of the capacitor portion 10, but S1>S2 may be satisfied on at least one of the main surfaces of the capacitor portion 10.

The ratio of S1 to S2, that is, S1/S2 preferably satisfies 1<S1/S2<3.5, or more preferably, satisfies 1.5<S1/S2<3.

Comparison between S1 and S2, for example, S1>S2 or S1/S2 is determined based on the areas of the first outer electrode layer 31 and the second outer electrode layer 32 disposed on the same main surface of the capacitor portion 10.

Preferably, the cathode layer 12 includes the solid electrolyte layer 12A disposed at the surface of the dielectric layer 13, a first conductor layer 12B disposed on the surface of the solid electrolyte layer 12A, and the second conductor layer 12C disposed on the surface of the first conductor layer 12B to be electrically directly connected to the second through-hole conductor 42. Thus, the second through-hole conductor 42 can be easily electrically directly connected to the cathode layer 12.

In the example illustrated in FIG. 1, the same elements (components) are disposed on both main surfaces of the core portion 11A of the anode plate 11. This can also reduce occurrence of warpage of the capacitor element 1. In addition, the electrostatic capacity of the capacitor portion 10 can be improved.

In addition, the area of the first through-hole conductor 41 and the area of the second through-hole conductor 42 disposed at the capacitor element 1 are preferably the same, and the number of first through-hole conductors 41 and the number of second through-hole conductors 42 disposed at the capacitor element 1 are more preferably the same. Thus, the heat dissipation properties of the capacitor element 1 can be uniformed.

Preferably, the through-hole conductors 40 (more specifically, the first through-hole conductor 41 and the second through-hole conductor 42 are not distinguished from each other) disposed at the capacitor element 1 are arranged at an equal pitch. This can also uniform the heat dissipation properties of the capacitor element 1. In addition, removal called delamination, for example, removal of the cathode layer from the anode plate can be reduced.

The capacitor portion 10 further preferably includes insulating mask layers 25 disposed around the through-hole conductors 40 at at least one of the main surfaces of the anode plate 11.

In the example illustrated in FIG. 1, each insulating mask layer 25 is disposed between the first through-hole conductor 41 and the cathode layer 12. In addition, in the example illustrated in FIG. 1, a space between the second through-hole conductor 42 and the capacitor portion 10 (particularly, the anode plate 11) is filled with the insulating member 22, and the insulating mask layer 25 is disposed between the insulating member 22 and the cathode layer 12 (for example, the solid electrolyte layer 12A).

The capacitor portion 10 may further include the insulating mask layer 25 at at least one of the main surfaces of the anode plate 11 to surround the cathode layer 12 (for example, the solid electrolyte layer 12A, the same applies throughout this paragraph below). When the cathode layer 12 is surrounded by the insulating mask layer 25, the insulating properties between the anode plate 11 and the cathode layer 12 is retained, and a short circuit between these is reduced. Although the insulating mask layer 25 may be disposed to surround a part of the cathode layer 12, but preferably, the insulating mask layer 25 is disposed to surround the entire periphery of the cathode layer 12.

FIG. 5 is a schematic cross-sectional view of another example of a capacitor element according to the first embodiment of the present disclosure.

A capacitor element 2 illustrated in FIG. 5 further includes inner via conductors 60 each disposed to extend through the seal layer 20 in the thickness direction, and each having one end portion electrically connected to the second outer electrode layer 32 and another end portion electrically connected to the corresponding cathode layer 12. Providing the inner via conductors 60 enables further improvement of the heat dissipation properties. In addition, providing the inner via conductors 60 enables improvement of adhesion between layers and reduction of occurrence of delamination.

In the example illustrated in FIG. 5, one end portion of each inner via conductor 60 is drawn out to the surface of the seal layer 20.

Each inner via conductor 60 is electrically connected to the cathode layer 12. Thus, the cathode layer 12 is electrically drawn out of the seal layer 20 through the inner via conductor 60 and the second through-hole conductor 42, and is electrically connectable to the outside of the seal layer 20. One, two, or more inner via conductors 60 may be electrically connected to the cathode layer 12.

Although not illustrated in FIG. 5, the capacitor element 2 may include the inner via conductor 60 electrically connected to the anode plate 11. In this case, the anode plate 11 is electrically drawn out of the seal layer 20 through the inner via conductor 60, and is electrically connectable to the outside of the seal layer 20. One, two, or more inner via conductors 60 may be electrically connected to the anode plate 11.

Hereafter, the detailed structures of, for example, the capacitor elements 1 and 2 are described.

The flat plate shape of the capacitor portion 10 when viewed in the thickness direction is, for example, a polygon such as a rectangle (a square or a rectangle), a quadrilateral excluding a rectangle, a triangle, a pentagon, or a hexagon, a circle, an ellipse, or a shape combining any two or more of these. The flat plate shape of the capacitor portion 10 may be, for example, an L shape, a C shape (an angular C shape), or a staircase shape.

Preferably, the anode plate 11 is formed from a valve metal having a so-called valve function. A valve metal is, for example, a single metal such as aluminum, tantalum, niobium, titanium, or zirconium, or an alloy containing at least one of these metals. Among these, aluminum or an aluminum alloy is preferable.

The anode plate 11 preferably has a flat plate shape, or more preferably has a foil shape. Herein, “a flat plate shape” includes “a foil shape”.

The anode plate 11 may include the porous portion 11B at at least one of the main surfaces of the core portion 11A. More specifically, the anode plate 11 may include the porous portion 11B at only one of the main surfaces of the core portion 11A as in the second embodiment described below, or may include the porous portions 11B on both main surfaces of the core portion 11A. The porous portion 11B is preferably a porous layer disposed at the surface of the core portion 11A, or is more preferably an etching layer.

Preferably, the thickness of the anode plate 11 before undergoing an etching process is greater than or equal to 60 μm and less than or equal to 200 μm. Preferably, the thickness of the core portion 11A left unetched after the etching process is greater than or equal to 15 μm, and less than or equal to 70 μm. The thickness of the porous portion 11B is designed in accordance with a required withstanding voltage and a required electrostatic capacity, and preferably greater than or equal to 10 μm and less than or equal to 180 μm including the porous portions 11B on both sides of the core portion 11A.

Preferably, the pore size in the porous portion 11B is greater than or equal to 10 nm, and less than or equal to 600 nm. The pore size in the porous portion 11B refers to a median diameter D50 measured by a mercury porosimeter. The pore size in the porous portion 11B can be controlled by adjusting, for example, various conditions in etching.

The dielectric layer 13 disposed at the surface of the porous portion 11B is porous by reflecting the state of the surface of the porous portion 11B, and has a surface shape with fine irregularities. Preferably, the dielectric layer 13 is formed from an oxide film of the above valve metal. For example, when aluminum foil is used as the anode plate 11, and an anode oxidation treatment (also referred to as a chemical conversion treatment) is performed on the surface of aluminum foil in a solution containing, for example, ammonium adipate to form the dielectric layer 13 from an oxide film.

The thickness of the dielectric layer 13 is designed in accordance with a required withstanding voltage and a required electrostatic capacity, but preferably greater than or equal to 10 nm and less than or equal to 100 nm.

When the cathode layer 12 includes the solid electrolyte layer 12A, a conducting polymer such as polypyrrole, polythiophene, or polyaniline is used as an example of a material forming the solid electrolyte layer 12A. Among these, polythiophene is preferable, and poly(3,4-ethylenedioxythiophene) called PEDOT is particularly preferable. The conducting polymer may contain a dopant such as polystyrene sulfonic acid (PSS). The solid electrolyte layer 12A preferably includes an inner layer that fills pores (recesses) of the dielectric layer 13, and an outer layer that covers the dielectric layer 13.

The thickness of the solid electrolyte layer 12A from the surface of the porous portion 11B is preferably greater than or equal to 2 μm, and less than or equal to 20 μm.

The solid electrolyte layer 12A is formed by a method such as forming a polymer film formed from poly(3,4-ethylenedioxythiophene) on the surface of the dielectric layer 13 using a process liquid containing a monomer such as 3,4-ethylenedioxythiophene, or applying a polymer dispersion liquid formed from poly(3,4-ethylenedioxythiophene) to the surface of the dielectric layer 13 and drying the liquid.

The solid electrolyte layer 12A can be formed in a predetermined area by applying the above process liquid or dispersion liquid to the surface of the dielectric layer 13 with a method such as sponge transfer, screen printing, dispenser application, or ink-jet printing.

When each cathode layer 12 includes the first conductor layer 12B and the second conductor layer 12C, the first conductor layer 12B and the second conductor layer 12C each include at least one of an electroconductive resin layer and a metal layer. Each of the first conductor layer 12B and the second conductor layer 12C may be simply formed from an electroconductive resin layer or a metal layer, but the first conductor layer 12B is preferably simply formed from an electroconductive resin layer, and the second conductor layer 12C is preferably simply formed from a metal layer. The first conductor layer 12B preferably covers the entire surface of the solid electrolyte layer 12A.

An electroconductive adhesive layer (an electroconductive paste layer) containing at least one of electroconductive fillers selected from the group consisting of a silver filler, a copper filler, a nickel filler, and a carbon filler is used as an example of the electroconductive resin layer.

A metal plating layer or a metal foil layer is used as an example of the metal layer. The metal layer is preferably formed from at least one of metals selected from the group consisting of nickel, copper, silver, and alloys including these metals as a main component. The term “main component” refers to the element with the largest weight ratio.

The first conductor layer 12B includes, for example, a carbon paste layer disposed at the surface of the solid electrolyte layer 12A, and a copper paste layer disposed at the surface of a carbon paste layer.

The second conductor layer 12C includes the copper layer 12Cu formed from, for example, a copper plating layer or a copper foil layer.

When the first conductor layer 12B includes a copper paste layer, the thickness d1 of the copper layer 12Cu of the cathode layer 12 corresponds to a thickness of the combination of the copper layer 12Cu of the second conductor layer 12C and the copper paste layer of the first conductor layer 12B.

The carbon paste layer of the first conductor layer 12B is disposed to electrically and mechanically connect the solid electrolyte layer 12A and the copper paste layer of the first conductor layer 12B. The carbon paste layer can be formed in a predetermined area by applying carbon paste to the surface of the solid electrolyte layer 12A with a method such as sponge transfer, screen printing, dispenser application, or ink-jet printing. Preferably, while the carbon paste layer is in a viscous state before being dried, a copper paste layer is laminated on the carbon paste layer in the subsequent process. The thickness of the carbon paste layer is preferably greater than or equal to 2 μm and less than or equal to 50 μm.

The copper paste layer of the first conductor layer 12B can be formed in a predetermined area by applying copper paste to the surface of the carbon paste layer with a method such as sponge transfer, screen printing, application with spraying, dispenser application, or ink-jet printing. The thickness of the copper paste layer is preferably greater than or equal to 2 μm and less than or equal to 50 μm.

The copper plating layer of the second conductor layer 12C can be formed in a predetermined area by deposition with electrolytic plating, electroless plating, sputtering, or vacuum deposition, and then patterning with etching (dry or wet). The thickness of the copper plating layer is preferably greater than or equal to 2 μm and less than or equal to 35 μm.

The copper foil layer of the second conductor layer 12C can be formed in a predetermined area by laminating, with a pressing machine, copper foil patterned with etching (dry or wet) or by laminating copper foil with a pressing machine and then patterning the copper foil with etching (dry or wet). The thickness of the copper foil layer is preferably greater than or equal to 3 μm and less than or equal to 35 μm.

The seal layer 20 is formed from an insulating member. In this case, the seal layer 20 is preferably formed from an insulating resin.

Epoxy resin or phenol resin is used as an example of an insulating resin forming the seal layer 20.

Preferably, the seal layer 20 further includes a filler.

An inorganic filler such as silica particles or alumina particles is used as a filler contained in the seal layer 20.

A layer such as a stress relaxation layer or a moisture-proof film may be disposed between the capacitor portion 10 and the seal layer 20.

The insulating mask layers 25 are formed from an insulating member. In this case, the insulating mask layers 25 are preferably formed from an insulating resin.

As an example of the insulating resin forming the insulating mask layers 25, polyphenylsulfone resin, polyethersulfone resin, cyanate ester resin, fluorocarbon polymer (tetrafluoroethylene, or perfluoroalkylvinylether-tetrafluoroethylene copolymer), polyimide resin, polyamide-imide resin, epoxy resin, or a derivative or a precursor of any of these is used.

The insulating mask layers 25 may be formed from the same resin as the seal layer 20. Unlike the seal layer 20, when the insulating mask layers 25 contain an inorganic filler, the effective capacitance of the capacitor portion 10 may be adversely affected. Thus, the insulating mask layers 25 are preferably formed from a single system of resin.

The insulating mask layers 25 can be formed in predetermined areas by applying a masking material such as a composite containing an insulating resin to the surface of the porous portion 11B with a method such as sponge transfer, screen printing, dispenser application, or ink-jet printing.

The insulating mask layers 25 may be formed on the porous portion 11B before the dielectric layer 13 is formed or after the dielectric layer 13 is formed.

The first outer electrode layer 31 is electrically connected to the anode plate 11. In the example illustrated in FIG. 1, the first outer electrode layer 31 is disposed at the surface of the first through-hole conductor 41, and functions as a connection terminal of the capacitor portion 10. In the example illustrated in FIG. 1, the first outer electrode layer 31 is electrically connected to the anode plate 11 with the first through-hole conductor 41, and functions as a connection terminal for the anode plate 11.

A metal material containing a low-resistance metal such as silver, gold, or copper is used as an example of a material of the first outer electrode layer 31. In this case, the first outer electrode layer 31 is formed by a method such as plating the surface of the first through-hole conductor 41.

To improve the adhesion between the first outer electrode layer 31 and another member, here, the adhesion between the first outer electrode layer 31 and the first through-hole conductor 41, a mixture (an electroconductive paste material) of a resin and at least one of electroconductive fillers selected from the group consisting of a silver filler, a copper filler, a nickel filler, and a carbon filler may be used as a material of the first outer electrode layer 31.

The first outer electrode layer 31 may include the copper layer 31Cu formed from, for example, a copper paste layer, a copper plating layer, or a copper foil layer. The copper paste layer, the copper plating layer, or the copper foil layer forming the first outer electrode layer 31 can be formed in the same manner as the copper paste layer forming the first conductor layer 12B or the copper plating layer or the copper foil layer forming the second conductor layer 12C.

The second outer electrode layer 32 is electrically connected to the cathode layer 12. In the example illustrated in FIG. 1, the second outer electrode layer 32 is disposed at the surface of the second through-hole conductor 42, and functions as a connection terminal of the capacitor portion 10. In the example illustrated in FIG. 1, the second outer electrode layer 32 is electrically connected to the cathode layer 12 with the second through-hole conductor 42, and functions as a connection terminal for the cathode layer 12.

A metal material containing a low-resistance metal such as silver, gold, or copper is used as an example of a material of the second outer electrode layer 32. In this case, the second outer electrode layer 32 is formed by a method such as plating the surface of the second through-hole conductor 42.

To improve the adhesion between the second outer electrode layer 32 and another member, here, the adhesion between the second outer electrode layer 32 and the second through-hole conductor 42, a mixture (an electroconductive paste material) of a resin and at least one of electroconductive fillers selected from the group consisting of a silver filler, a copper filler, a nickel filler, and a carbon filler may be used as a material of the second outer electrode layer 32.

The second outer electrode layer 32 may include the copper layer 32Cu formed from, for example, a copper paste layer, a copper plating layer, or a copper foil layer. The copper paste layer, the copper plating layer, or the copper foil layer forming the second outer electrode layer 32 can be formed in the same manner as the copper paste layer forming the first conductor layer 12B or the copper plating layer or the copper foil layer forming the second conductor layer 12C.

Preferably, the first outer electrode layer 31 and the second outer electrode layer 32 are formed from the same material in terms of at least the type, but may be formed from different materials.

When multiple capacitor portions 10 are disposed, each of the multiple capacitor portions 10 may include the first outer electrode layer 31 electrically connected to the anode plate 11, and the second outer electrode layer 32 electrically connected to the cathode layer 12, or at least one of the first outer electrode layer 31 and the second outer electrode layer 32 may be shared between the multiple capacitor portions 10.

In the example illustrated in FIG. 1, the first outer electrode layer 31 and the second outer electrode layer 32 are disposed on each of both main surfaces of the seal layer 20, but may be disposed simply on one main surface of the seal layer 20.

The first through-hole conductor 41 is electrically connected to the anode plate 11 at the inner wall surface of the first through-hole 51. More specifically, preferably, the first through-hole conductor 41 is electrically connected to the end surface of the anode plate 11 facing the inner wall surface of the first through-hole 51 in a plane direction. Thus, the anode plate 11 is electrically drawn to the outside with the first through-hole conductor 41.

Preferably, the core portion 11A and the porous portions 11B are exposed at the end surface of the anode plate 11 electrically connected to the first through-hole conductor 41. In this case, in addition to the core portion 11A, the porous portions 11B are also electrically connected to the first through-hole conductor 41.

As illustrated in FIG. 2, when viewed in the thickness direction, preferably, the first through-hole conductor 41 is electrically connected to the anode plate 11 throughout the periphery of the first through-hole 51. In this case, the heat dissipation path increases, and thus, the heat dissipation properties of the capacitor element 1 can be further improved. In addition, the connection resistance between the anode plate 11 and the first through-hole conductor 41 is more likely to be lowered, and thus equivalent series resistance (ESR) is more likely to be lowered.

The first through-hole conductor 41 is formed by a method such as in the manner described below. First, the first through-hole 51 extending through the capacitor portion 10 and the seal layer 20 in the thickness direction is formed by a method such as drilling or laser processing. Then, the inner wall surface of the first through-hole 51 is metalized with a metal material containing a low-resistance metal such as copper, gold, or silver to form the first through-hole conductor 41. To form the first through-hole conductor 41, metalizing the inner wall surface of the first through-hole 51 with, for example, electroless copper plating or electrolytic copper plating facilitates processing. Except for the method of metalizing the inner wall surface of the first through-hole 51, the first through-hole conductor 41 may be formed by filling the first through-hole 51 with, for example, a metal material or a composite material containing metal and resin.

An anode connection layer may be disposed between the anode plate 11 and the first through-hole conductor 41 in the plane direction. More specifically, the anode plate 11 and the first through-hole conductor 41 may be electrically connected with an anode connection layer interposed therebetween.

When the anode connection layer is disposed between the anode plate 11 and the first through-hole conductor 41 in the plane direction, the anode connection layer functions as a barrier layer to protect the anode plate 11, or more specifically, as a barrier layer to protect the core portion 11A and the porous portion 11B. When the anode connection layer functions as a barrier layer to protect the anode plate 11, dissolution of the anode plate 11 occurring during a chemical solution treatment performed to form the outer electrode layer 30 (for example, the first outer electrode layer 31) is reduced, and intrusion of the chemical solution into the capacitor portion 10 is reduced. Thus, the reliability is more likely to be improved.

Preferably, the anode connection layer includes a layer containing nickel as a main component. In this case, damages on, for example, metal (for example, aluminum) forming the anode plate 11 are reduced, and thus the barrier property of the anode connection layer to protect the anode plate 11 is more likely to be improved.

Alternatively, no anode connection layer may be disposed between the anode plate 11 and the first through-hole conductor 41 in the plane direction. In this case, the first through-hole conductor 41 may be directly connected to the end surface of the anode plate 11.

In the example illustrated in FIG. 1, the first through-hole conductor 41 is disposed only at the inner wall surface of the first through-hole 51. In this case, a resin-filled portion 91 formed by being filled with a resin material may be formed in the first through-hole 51. The resin-filled portion 91 is located in a space surrounded by the first through-hole conductor 41 in the first through-hole 51. When the space inside the first through-hole 51 is occupied by forming the resin-filled portion 91, occurrence of delamination of the first through-hole conductor 41 is reduced. The resin-filled portion 91 may be a conductor or an insulator.

In the example illustrated in FIG. 1, the second through-hole conductor 42 is electrically connected to the cathode layer 12, more specifically, the second conductor layer 12C at the inner wall surface of the second through-hole 52. More specifically, preferably, the second through-hole conductor 42 is electrically connected to the end surface of the second conductor layer 12C facing the inner wall surface of the second through-hole 52 in the plane direction. Thus, the cathode layer 12 is electrically drawn to the outside with the second through-hole conductor 42.

As illustrated in FIG. 3, when viewed in the thickness direction, preferably, the second through-hole conductor 42 is electrically connected to the cathode layer 12, or more specifically, the second conductor layer 12C throughout the periphery of the second through-hole 52. In this case, the heat dissipation path increases, and thus, the heat dissipation properties of the capacitor element 1 can be further improved. In addition, the connection resistance between the cathode layer 12 and the second through-hole conductor 42 is more likely to be lowered, and thus equivalent series resistance (ESR) is more likely to be lowered.

The second through-hole conductor 42 is formed, for example, in the manner described below. First, a through-hole 53 extending through the capacitor portion 10 in the thickness direction is formed by a method such as drilling or laser processing. Then, the through-hole 53 described above is filled with the insulating member 22. The portion filled with the insulating member 22 then undergoes, for example, drilling or laser processing to form the second through-hole 52. At this time, the diameter of the second through-hole 52 is set smaller than the diameter of the through-hole 53 filled with the insulating member 22. Thus, the insulating member 22 lies between the inner wall surface of the through-hole 53 formed previously and the inner wall surface of the second through-hole 52 in the plane direction. The inner wall surface of the second through-hole 52 is then metalized with a metal material containing a low-resistance metal such as copper, gold, or silver to form the second through-hole conductor 42. To form the second through-hole conductor 42, metalizing the inner wall surface of the second through-hole 52 with, for example, electroless copper plating or electrolytic copper plating facilitates processing. Instead of metalizing the inner wall surface of the second through-hole 52, the second through-hole conductor 42 may be formed by filling the second through-hole 52 with, for example, a metal material or a composite material containing metal and resin.

Preferably, the insulating member 22 is formed from an insulating resin. Epoxy resin or phenol resin is used as an example of an insulating resin forming the insulating member 22. In addition, preferably, the insulating member 22 contains a filler. An inorganic filler such as silica particles, alumina particles, or metal particles is used as a filler contained in the insulating member 22.

The insulating member 22 may be formed from the same material as the seal layer 20.

A cathode connection layer similar to an anode connection layer may be disposed between the second through-hole conductor 42 and the cathode layer 12, or particularly the second conductor layer 12C in the plane direction, but preferably, no cathode connection layer is disposed. In the latter case, the second through-hole conductor 42 may be directly connected to the end surface of the second conductor layer 12C.

In the example illustrated in FIG. 1, the second through-hole conductor 42 is disposed simply at the inner wall surface of the second through-hole 52. In this case, a resin-filled portion 92 formed by being filled with a resin material may be disposed in the second through-hole 52. The resin-filled portion 92 is located in a space surrounded by the second through-hole conductor 42 in the second through-hole 52. When the space inside the second through-hole 52 is occupied by forming the resin-filled portion 92, occurrence of delamination of the second through-hole conductor 42 is reduced. The resin-filled portion 92 may be a conductor or an insulator.

A metal material containing a low-resistance metal such as silver, gold, or copper is used as an example of a material of the inner via conductor 60.

The inner via conductor 60 is formed by a method such as plating the inner wall surface of a through-hole extending through the seal layer 20 in the thickness direction with the above metal material, or filling the through-hole with electroconductive paste and then performing thermal treatment on the electroconductive paste.

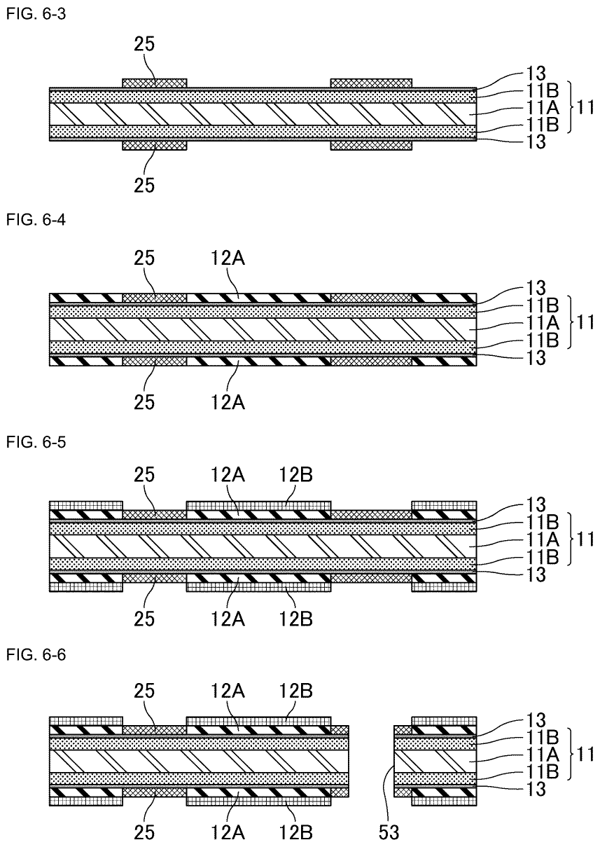

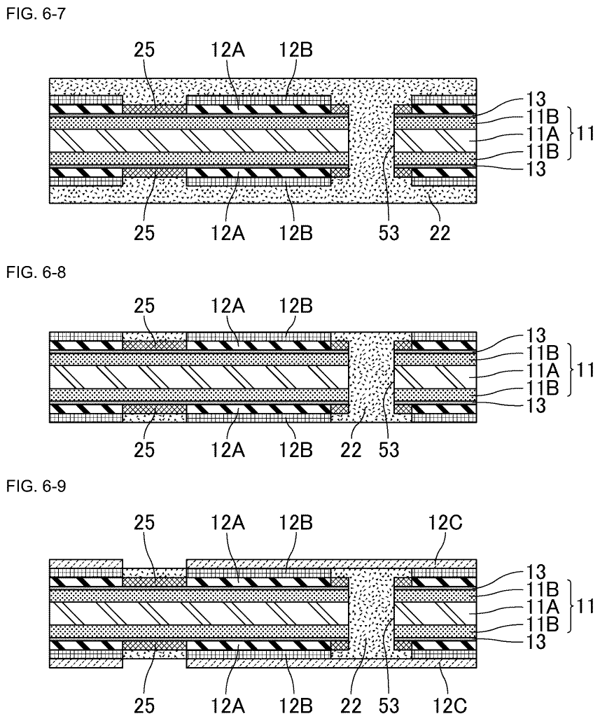

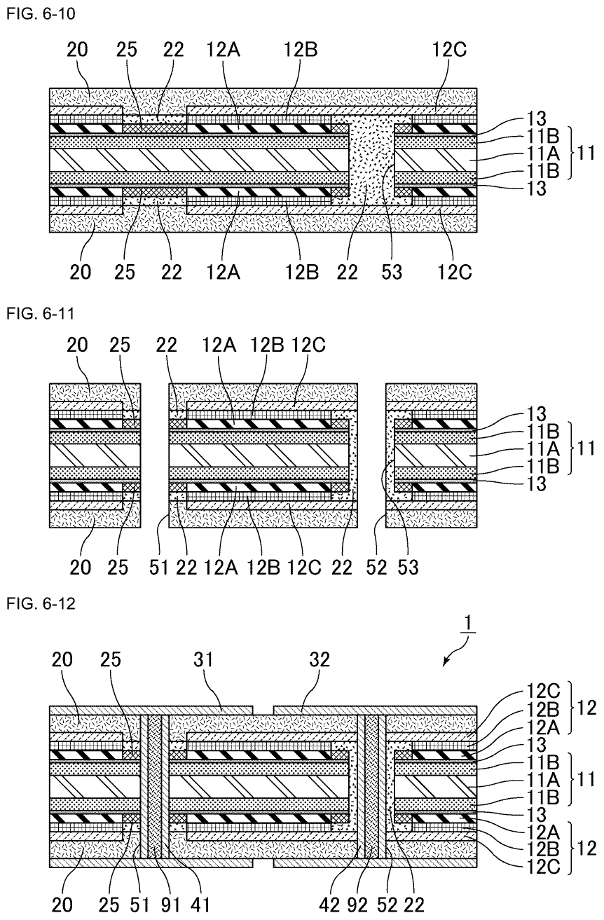

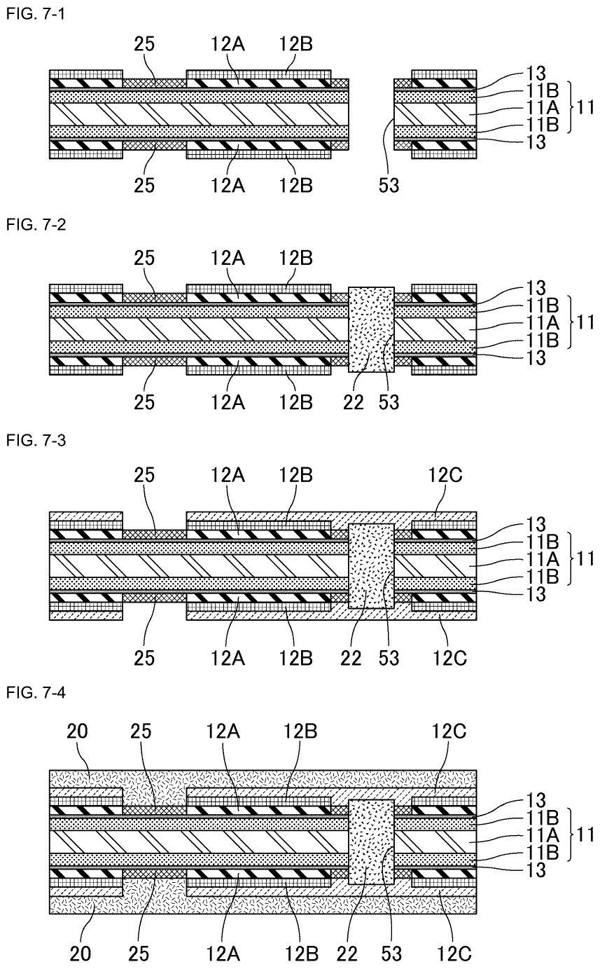

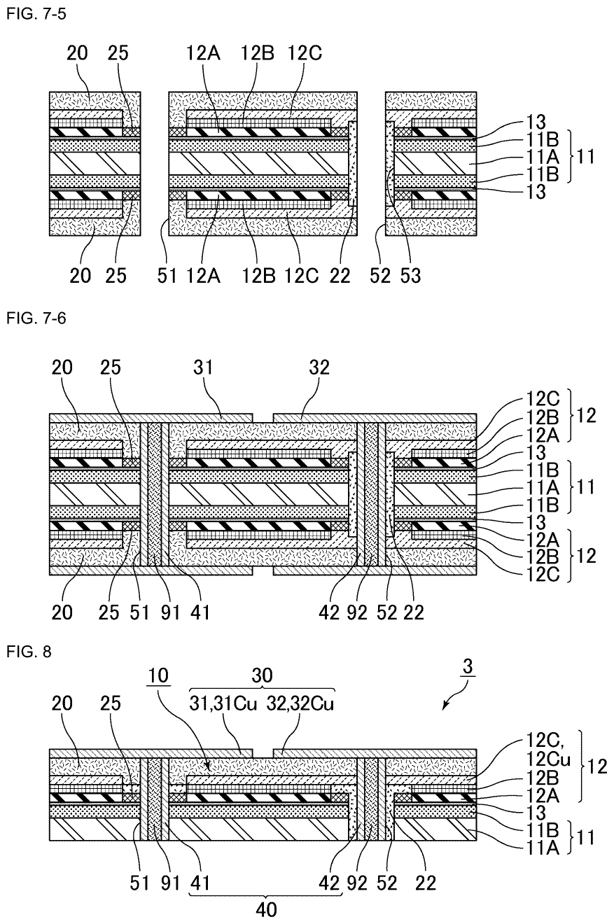

FIG. 6-1 to FIG. 6-12 are cross-sectional schematic views illustrating an example of a method for manufacturing the capacitor element illustrated in FIG. 1. FIG. 6-1 illustrates a process of preparing an anode plate. FIG. 6-2 illustrates a process of forming dielectric layers. FIG. 6-3 illustrates a process of forming insulating mask layers. FIG. 6-4 illustrates a process of forming solid electrolyte layers. FIG. 6-5 illustrates a process of forming first conductor layers. FIG. 6-6 illustrates a process of forming a through-hole. FIG. 6-7 illustrates a process of forming an insulating member. FIG. 6-8 illustrates a process of grinding an insulating member. FIG. 6-9 illustrates a process of forming second conductor layers. FIG. 6-10 illustrates a process of forming seal layers. FIG. 6-11 illustrates a process of forming a first through-hole and a second through-hole. FIG. 6-12 illustrates a process of forming through-hole conductors and outer electrode layers.

For example, the capacitor element 1 illustrated in FIG. 1 is formed in the manner described below.

First, as illustrated in FIG. 6-1, the anode plate 11 including the porous portions 11B on both main surfaces of the core portion 11A is prepared.

Thereafter, as illustrated in FIG. 6-2, the dielectric layers 13 are formed on the porous portions 11B.

Thereafter, as illustrated in FIG. 6-3, the insulating mask layers 25 are disposed on the dielectric layers 13.

Thereafter, as illustrated in FIG. 6-4, the solid electrolyte layers 12A are formed on the dielectric layers 13 in areas surrounded by the insulating mask layers 25.

Thereafter, as illustrated in FIG. 6-5, the first conductor layers 12B are formed on the solid electrolyte layers 12A.

Thereafter, as illustrated in FIG. 6-6, the through-hole 53 extending through the insulating mask layers 25, the dielectric layers 13, and the anode plate 11 is formed.

Thereafter, as illustrated in FIG. 6-7, the insulating member 22 is laminated to cover the insulating mask layers 25 and the first conductor layers 12B to fill the through-hole 53 with the insulating member 22.

Thereafter, as illustrated in FIG. 6-8, the insulating member 22 is ground to be thinned until the first conductor layers 12B are exposed.

Thereafter, as illustrated in FIG. 6-9, the second conductor layers 12C are formed on the first conductor layers 12B and the insulating members 22.

Thereafter, as illustrated in FIG. 6-10, the seal layers 20 are formed to cover the second conductor layers 12C and the insulating member 22.

Thereafter, as illustrated in FIG. 6-11, the first through-hole 51 extending through the seal layers 20, the insulating member 22, the insulating mask layers 25, the dielectric layers 13, and the anode plate 11, and the second through-hole 52 extending through the seal layers 20, the second conductor layers 12C, and the insulating member 22 are formed. The second through-hole 52 is located inside an area in which the through-hole 53 is formed.

Thereafter, as illustrated in FIG. 6-12, the first through-hole conductor 41 is formed in the first through-hole 51, and the second through-hole conductor 42 is formed in the second through-hole 52. The resin-filled portions 91 and 92 may be respectively formed in the first through-hole conductor 41 and the second through-hole conductor 42. Finally, the first outer electrode layers 31 are formed on the seal layers 20 to cover the first through-hole conductor 41, and the second outer electrode layers 32 are formed on the seal layers 20 to cover the second through-hole conductor 42.

FIG. 7-1 to FIG. 7-6 are cross-sectional schematic views of another example of a method for manufacturing the capacitor element illustrated in FIG. 1. FIG. 7-1 illustrates a state after a through-hole is formed. FIG. 7-2 illustrates a process of forming insulating members. FIG. 7-3 illustrates a process of forming second conductor layers. FIG. 7-4 illustrates a process of forming seal layers. FIG. 7-5 illustrates a process of forming a first through-hole and a second through-hole. FIG. 7-6 illustrates a process of forming through-hole conductors and outer electrode layers.

For example, the capacitor element 1 illustrated in FIG. 1 may be formed in the manner described below.

First, as illustrated in FIG. 7-1, as in the case illustrated in FIG. 6-1 to FIG. 6-6, the through-hole 53 extending through the insulating mask layers 25, the dielectric layers 13, and the anode plate 11 is formed.

Thereafter, as illustrated in FIG. 7-2, the insulating member 22 is formed only in the through-hole 53 by a method such as filling the through-hole 53 with a resin material, screen printing, dispenser application, or ink-jet printing.

Thereafter, as illustrated in FIG. 7-3 to FIG. 7-6, as in the case illustrated in FIG. 6-9 to FIG. 6-12, the second conductor layers 12C, the seal layers 20, the first through-hole 51, the second through-hole 52, the first through-hole conductor 41, the second through-hole conductor 42, the first outer electrode layers 31, and the second outer electrode layers 32 are formed. As appropriate, the resin-filled portions 91 and 92 may be formed.

### Second Embodiment

FIG. 8 is a schematic plan view of an example of a capacitor element according to a second embodiment of the present disclosure.

A capacitor element 3 illustrated in FIG. 8 includes an anode plate 11 including a porous portion 11B at only one main surface of a core portion 11A. The capacitor element 3 receives, on only one surface, components including a capacitor portion 10 (an anode plate 11, a dielectric layer 13, and a cathode layer 12), a seal layer 20, and an outer electrode layer 30 (a first outer electrode layer 31 and a second outer electrode layer 32).

In the example illustrated in FIG. 8, through-hole conductors 40 (a first through-hole conductor 41 and a second through-hole conductor 42) each have one end portion electrically connected to the outer electrode layer 30 and the other end portion exposed to the surface receiving no components including the capacitor portion 10.

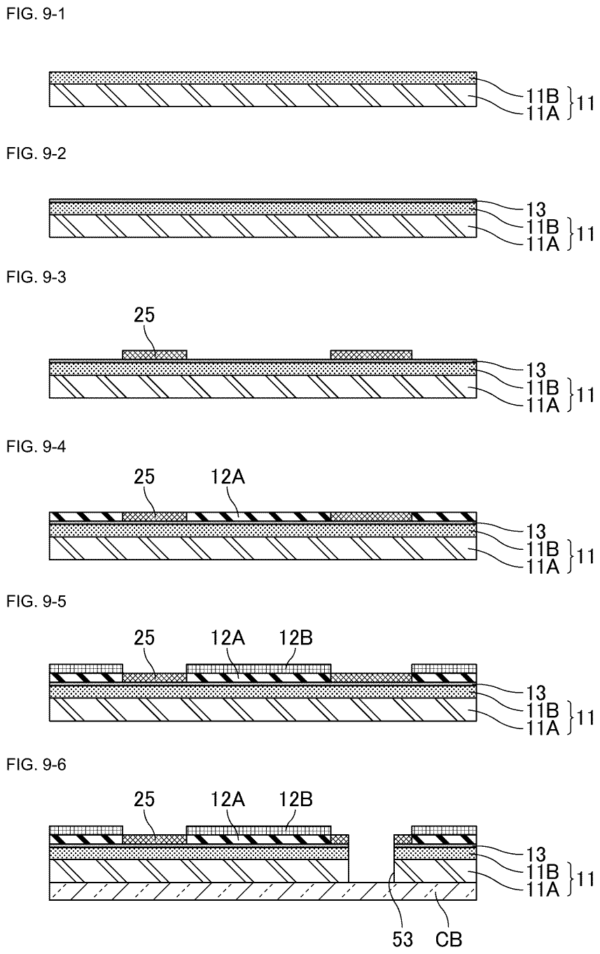

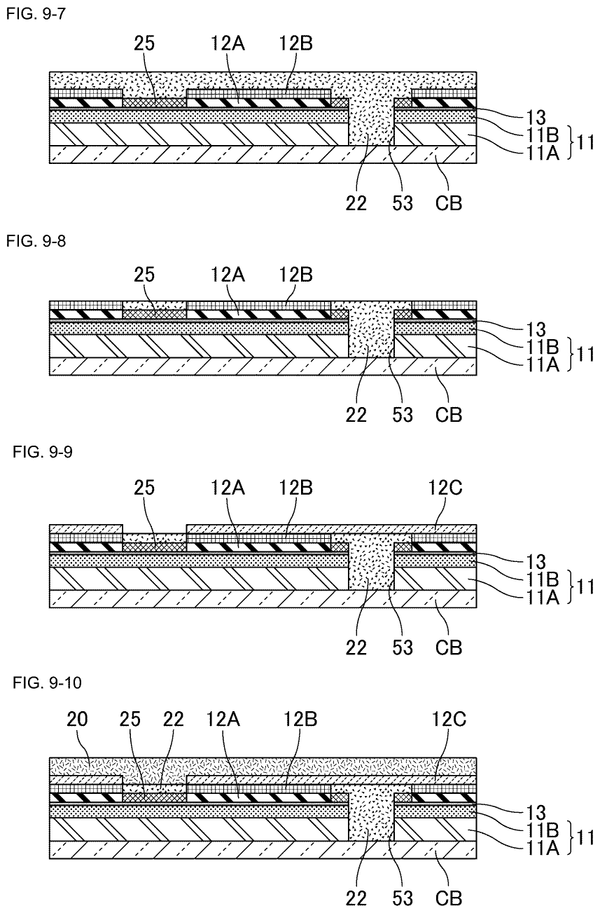

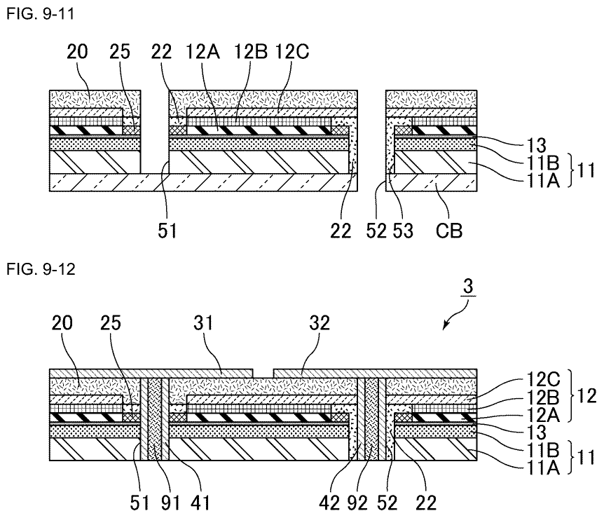

FIG. 9-1 to FIG. 9-12 are cross-sectional schematic views of an example of a method for manufacturing the capacitor element illustrated in FIG. 8. FIG. 9-1 illustrates a process of preparing an anode plate. FIG. 9-2 illustrates a process of forming a dielectric layer. FIG. 9-3 illustrates a process of forming an insulating mask layer. FIG. 9-4 illustrates a process of forming a solid electrolyte layer. FIG. 9-5 illustrates a process of forming a first conductor layer. FIG. 9-6 illustrates a process of forming a through-hole. FIG. 9-7 illustrates a process of forming an insulating member. FIG. 9-8 illustrates a process of grinding an insulating member. FIG. 9-9 illustrates a process of forming a second conductor layer. FIG. 9-10 illustrates a process of forming a seal layer. FIG. 9-11 illustrates a process of forming a first through-hole and a second through-hole. FIG. 9-12 illustrates a process of forming through-hole conductors and an outer electrode layer.

For example, the capacitor element 3 illustrated in FIG. 8 may be formed in the manner described below.

First, as illustrated in FIG. 9-1, the anode plate 11 including the porous portion 11B is prepared on only one main surface of the core portion 11A.

Subsequently, as illustrated in FIG. 9-2 to FIG. 9-5, as in the case illustrated in FIG. 6-2 to FIG. 6-5, the dielectric layer 13, the insulating mask layer 25, the solid electrolyte layer 12A, and the first conductor layer 12B are formed.

Subsequently, as illustrated in FIG. 9-6, as in the case illustrated in FIG. 6-6, a capacitor element sheet having a through-hole 53 is placed on a carrier board CB.

Thereafter, as illustrated in FIG. 9-7 to FIG. 9-12, as in the case illustrated in FIG. 6-7 to FIG. 6-12, the insulating member 22 is laminated and ground, and then the second conductor layer 12C, the seal layer 20, the first through-hole 51, the second through-hole 52, the first through-hole conductor 41, the second through-hole conductor 42, the first outer electrode layer 31, and the second outer electrode layer 32 are formed. As appropriate, the resin-filled portions 91 and 92 may be formed.

### OTHER EMBODIMENTS

A capacitor element according to the present disclosure is not limited to the above embodiments, and may be applied or modified in various manners in relation to, for example, components or manufacturing conditions of the capacitor element within the scope of the present disclosure.

A capacitor element according to the present disclosure may include one or more capacitor portions inside a seal layer.

When a capacitor element according to the present disclosure includes multiple capacitor portions inside a seal layer, adjacent two of the capacitor portions may be physically separated from each other. Thus, the adjacent capacitor portions may be electrically separated or connected to each other. Preferably, a portion where the adjacent capacitor portions are separated from each other is filled with an insulating member such as a seal layer. The distance between the adjacent capacitor portions may be uniform in the thickness direction or may be decreasing in the thickness direction.

When a capacitor element according to the present disclosure includes multiple capacitor portions inside the seal layer, the multiple capacitor portions may be arranged in the plane direction, laminated in the thickness direction, or arranged in these directions in combination. The multiple capacitor portions may be arranged regularly or irregularly. The capacitor elements may have the same size or shape, or partially or entirely different sizes or shapes. The capacitor elements preferably have the same structure, but may have different structures.

A capacitor element according to the present disclosure is preferably usable as a material of a compound electronic component. Such a compound electronic component includes, for example, a capacitor element according to the present disclosure, an outer electrode layer disposed at a surface of a seal layer of the capacitor element and electrically connected to an anode plate and a cathode layer of the capacitor element, and an electronic component connected to the outer electrode layer.

In the compound electronic component, the electronic component connected to the outer electrode layer may be a passive element or an active element. Both of the passive element and the active element may be connected to the outer electrode layer, or either one of the passive element and the active element may be connected to the outer electrode layer. Alternatively, a composite of the passive element and the active element may be connected to the outer electrode layer.

Examples of the passive element include an inductor. Examples of the active element include a memory, a graphical processing unit (GPU), a central processing unit (CPU), a microprocessing unit (MPU), and a power management integrated circuit (PMIC).

A capacitor element according to the present disclosure has a sheet shape as a whole. Thus, in the compound electronic component, the capacitor element can be treated as a mount board, and electronic components can be mounted on the capacitor element. In addition, when electronic components with a sheet shape are mounted on the capacitor element, the capacitor element and the electronic component can be connected in the thickness direction with a through-hole conductor extending through each electronic component in the thickness direction. Thus, the active element and the passive element can be formed as an integrated module.

For example, when a capacitor element according to the present disclosure is electrically connected between a voltage regulator including a semiconductor active element and a load to which a converted direct-current voltage is supplied, a switching regulator can be formed.

After a circuit layer is formed on one of surfaces of a capacitor matrix sheet in which multiple capacitor elements according to the present disclosure are laid out, the compound electronic component may be connected to the passive element or the active element.

Alternatively, a capacitor element according to the present disclosure may be disposed in a cavity portion formed in a substrate in advance, and embedded in the cavity portion with resin, and then a circuit layer may be formed over the resin. In another cavity portion formed in the substrate, another electronic component (a passive element or an active element) may be disposed.

Alternatively, a capacitor element according to the present disclosure may be mounted on a smooth carrier such as a wafer or glass, an outer layer portion may then be formed from resin, a circuit layer may then be formed, and the capacitor element may then be connected to the passive element or the active element.

The present application discloses the description below.

<1> A capacitor element, comprising: a capacitor portion including: an anode plate including a core portion and a porous portion at at least one main surface of the core portion, a dielectric layer at a surface of the porous portion, and a cathode layer at a surface of the dielectric layer; a seal layer covering the capacitor portion; a first through-hole conductor extending through the capacitor portion and the seal layer in a thickness direction and electrically directly connected to the anode plate, and having two end portions drawn out to a surface of the seal layer; a second through-hole conductor extending through the capacitor portion and the seal layer in the thickness direction and electrically directly connected to the cathode layer, and having two end portions drawn out to the surface of the seal layer; a first outer electrode layer at the surface of the seal layer and electrically connected to the first through-hole conductor, wherein at least a part of the first outer electrode layer overlaps the cathode layer in the thickness direction; and a second outer electrode layer at a surface of the seal layer and electrically connected to the second through-hole conductor.

<2> The capacitor element according to <1>, wherein the cathode layer includes a first copper layer, the first outer electrode layer includes a second copper layer, and the second outer electrode layer includes a third copper layer, and wherein d1≥d2 and d1≥d3 where a thickness of the first copper layer of the cathode layer is denoted with d1, a thickness of the second copper layer of the first outer electrode layer is denoted with d2, and a thickness of the third copper layer of the second outer electrode layer is denoted with d3.

<3> The capacitor element according to <1> or <2>, wherein S1>S2 where an area of the first outer electrode layer is denoted with S1, and an area of the second outer electrode layer is denoted with S2.

<4> The capacitor element according to any one of <1> to <3>, further comprising: an inner via conductor extending through the seal layer in the thickness direction, the inner via conductor having a first end portion thereof electrically connected to the second outer electrode layer and a second end portion thereof electrically connected to the cathode layer.

<5> The capacitor element according to any one of <1> to <4>, wherein the cathode layer includes a solid electrolyte layer on a surface of the dielectric layer, a first conductor layer on a surface of the solid electrolyte layer, and a second conductor layer on a surface of the first conductor layer and electrically directly connected to the second through-hole conductor.

### REFERENCE SIGNS LIST

1, 2, 3 capacitor element
10 capacitor portion
11 anode plate
11A core portion
11B porous portion
12 cathode layer
12A solid electrolyte layer
12B first conductor layer
12C second conductor layer
12Cu copper layer of cathode layer
13 dielectric layer
20 seal layer
22 insulating member
25 insulating mask layer
30 outer electrode layer
31 first outer electrode layer
31Cu copper layer of first outer electrode layer
32 second outer electrode layer
32Cu copper layer of second outer electrode layer
40 through-hole conductor
41 first through-hole conductor
42 second through-hole conductor
51 first through-hole
52 second through-hole
53 through-hole
60 inner via conductor
91, 92 resin-filled portion

1. A capacitor element, comprising:
a capacitor portion including:
an anode plate including a core portion and a porous portion at at least one main surface of the core portion,
a dielectric layer at a surface of the porous portion, and
a cathode layer at a surface of the dielectric layer;
a seal layer covering the capacitor portion;
a first through-hole conductor extending through the capacitor portion and the seal layer in a thickness direction and electrically directly connected to the anode plate, and having two end portions drawn out to a surface of the seal layer;
a second through-hole conductor extending through the capacitor portion and the seal layer in the thickness direction and electrically directly connected to the cathode layer, and having two end portions drawn out to the surface of the seal layer;
a first outer electrode layer at the surface of the seal layer and electrically connected to the first through-hole conductor, wherein at least a part of the first outer electrode layer overlaps the cathode layer in the thickness direction; and
a second outer electrode layer at a surface of the seal layer and electrically connected to the second through-hole conductor.

2. The capacitor element according to claim 1,
wherein the cathode layer includes a first copper layer, the first outer electrode layer includes a second copper layer, and the second outer electrode layer includes a third copper layer, and
wherein d1≥d2 and d1≥d3 where a thickness of the first copper layer of the cathode layer is denoted with d1, a thickness of the second copper layer of the first outer electrode layer is denoted with d2, and a thickness of the third copper layer of the second outer electrode layer is denoted with d3.

3. The capacitor element according to claim 2, wherein 1<d1/d2<3.

4. The capacitor element according to claim 2, wherein 1.5<d1/d2<2.5.

5. The capacitor element according to claim 3, wherein 1<d1/d3<3.

6. The capacitor element according to claim 4, wherein 1.5<d1/d3<2.5.

7. The capacitor element according to claim 2, wherein 1<d1/d3<3.

8. The capacitor element according to claim 2, wherein 1.5<d1/d3<2.5.

9. The capacitor element according to claim 1, wherein S1>S2 where an area of the first outer electrode layer is denoted with S1, and an area of the second outer electrode layer is denoted with S2.

10. The capacitor element according to claim 9, wherein 1<S1/S2<3.5.

11. The capacitor element according to claim 9, wherein 1.5<S1/S2<3.

12. The capacitor element according to claim 2, wherein S1>S2 where an area of the first outer electrode layer is denoted with S1, and an area of the second outer electrode layer is denoted with S2.

13. The capacitor element according to claim 12, wherein 1<S1/S2<3.5.

14. The capacitor element according to claim 12, wherein 1.5<S1/S2<3.

15. The capacitor element according to claim 1, further comprising:
an inner via conductor extending through the seal layer in the thickness direction, the inner via conductor having a first end portion thereof electrically connected to the second outer electrode layer and a second end portion thereof electrically connected to the cathode layer.

16. The capacitor element according to claim 1, wherein the cathode layer includes:
a solid electrolyte layer on a surface of the dielectric layer,
a first conductor layer on a surface of the solid electrolyte layer, and
a second conductor layer on a surface of the first conductor layer and electrically directly connected to the second through-hole conductor.
